(19) United States
(12) Patent Application Publication
(10) Pub. No.: US 2024/0060270 A1
(43) Pub. Date: Feb. 22, 2024

(54) Electric Work Machine

(71) Applicant: Yanmar Holdings Co., Ltd., Osaka (JP)

(72) Inventors: Kensuke Kaneda, Osaka (JP); Takeshi Takaira, Fukuoka (JP); Kazunosuke Miyoshi, Fukuoka (JP); Shunnosuke Mizumachi, Fukuoka (JP); Kosuke Onitsuka, Fukuoka (JP)

(73) Assignee: Yanmar Holdings Co., Ltd., Osaka (JP)

(21) Appl. No.: 18/271,505

(22) PCT Filed: Dec. 23, 2021
(86) PCT No.: PCT/JP2021/047842

§ 371 Date: Jul. 10, 2023

(30) Foreign Application Priority Data
Jan. 15, 2021 (JP) 2021-004777

(51) Int. Cl. E02F 9/22

(52) U.S. Cl. CPC E02F 9/2217; E02F 9/2285; E02F 9/2246; E02F 9/2203

(57) ABSTRACT

This hydraulic shovel used as an electric work machine comprises: an electric motor, an inverter, a hydraulic actuator, a hydraulic pump, a direction switching valve, a pilot pump, a remote control valve, an electromagnetic valve, an accumulator, and a control unit. The accumulator is positioned in an oil path that branches from an oil path for pilot oil extending from the pilot pump to the electromagnetic valve, and accumulates the pilot pressure generated by the pilot pump. The control unit controls the inverter to stop the rotation of the electric motor after an interruption due to a depowered state of the electromagnetic valve.

### TECHNICAL FIELD

The present invention relates to an electric work machine.

### BACKGROUND ART

A conventional the hydraulic shovel driven by an engine has been proposed. For example, Patent Literature 1 discloses a hydraulic shovel having a configuration in which an accumulator is so placed as to branch from an oil path that communicates a pilot pump with an electromagnetic valve.

### CITATION LIST

### Patent Literature

Patent Literature 1: Japanese Unexamined Utility Model Application Publication No. Sho 64-053255

### DISCLOSURE OF INVENTION

### Problems to be Solved by the Invention

In a hydraulic shovel provided with an engine, even after a cut-off lever is raised thereby to issue a command to stop the engine, the rotation of a flywheel revolves an engine for a short time period. In contrast, in an electric hydraulic shovel in which the engine is replaced with an electric motor, the electric motor is greater in acceleration and deceleration than the engine; thus, raising the cut-off lever thereby to issue a command to stop the electric motor stops the electric motor at substantially the same timing. Thus, depending on the timing for raising the cut-off lever, the electric motor will stop earlier than the timing for cutting off the pilot primary pressure by an electromagnetic valve. In this case, the pressure reduction in an accumulator, which is so positioned as to branch from an oil path communicating the pilot pump with the electromagnetic valve, becomes large (the pilot pressure accumulated in the accumulator is removed). As a result; after the stop of the electric motor, the hydraulic actuator cannot be moved immediately, using the pilot pressure accumulated in the accumulator.

The present invention has been made to solve the problem; it is an object of the present invention to provide an electric work machine that is capable of keeping, after the stop of driving the electric motor stops, the pilot pressure's accumulation in an accumulator.

### Means for Solving the Problems

An electric work machine according to one aspect of the present invention includes: an electric motor; an inverter that supplies power to the electric motor; a hydraulic actuator that is driven by a supply of a hydraulic oil; a hydraulic pump that is driven by the electric motor, and supplies the hydraulic oil to the hydraulic actuator; a direction switching valve that controls a flow direction and flowrate of the hydraulic oil supplied from the hydraulic pump to the hydraulic actuator; and a pilot pump that is driven by the electric motor, and discharges a pilot oil serving as an input command to the direction switching valve; a remote control valve that, in response to an operation of an operator, controls a supply of the pilot oil from the pilot pump to the direction switching valve; an electromagnetic valve that controls the supply of the pilot oil from the pilot pump to the remote control valve; an accumulator that is positioned in an oil path that branches from the pilot oil's oil path extending from the pilot pump to the electromagnetic valve, and that accumulates a pilot pressure generated by the pilot pump; and a control unit that controls the inverter, wherein the control unit, after cutting off of the electromagnetic valve due to the electromagnetic valve (75) in a de-powered state, controls the inverter thereby to stop a rotation of the electric motor.

### Effect of the Invention

According to the above configuration, the pilot pressure's accumulation in the accumulator can be kept after the stop of driving an electric motor.

### BRIEF DESCRIPTION OF DRAWINGS

FIG. 1 is a side view showing a schematic configuration of a hydraulic shovel as an example of an electric work machine according to an embodiment of the present invention.

FIG. 2 is a block diagram schematically showing a configuration of control and hydraulic systems of the hydraulic shovel.

FIG. 3 is an illustration showing the relation between the turn position of a cut-off lever of the hydraulic shovel and the action state of a hydraulic actuator.

FIG. 4 is an illustration showing the turn position of the cut-off lever and the turn position of a key, relative to startability of an electric motor.

FIG. 5 is an illustration showing in detail the process from the rotation to stop of the electric motor.

FIG. 6 is a graph showing a control signal for stopping the rotation of the electric motor, and a transition of the actual rotation speed of the electric motor driven based on the control signal.

FIG. 7 is a graph showing another control signal for stopping the rotation of the electric motor, and a transition of the actual rotation speed of the electric motor driven based on the other control signal.

FIG. 8 is an illustration showing the process seen when the hydraulic actuator is actuated based on a key operation by an operator after stopping the rotation of the electric motor.

FIG. 9 is an illustration showing the process of stopping, by an idle stop control, the rotation of the electric motor.

### DESCRIPTION OF EMBODIMENTS

The following is a description of an embodiment of the present invention based on the drawings.

### [1. Electric Work Machine]

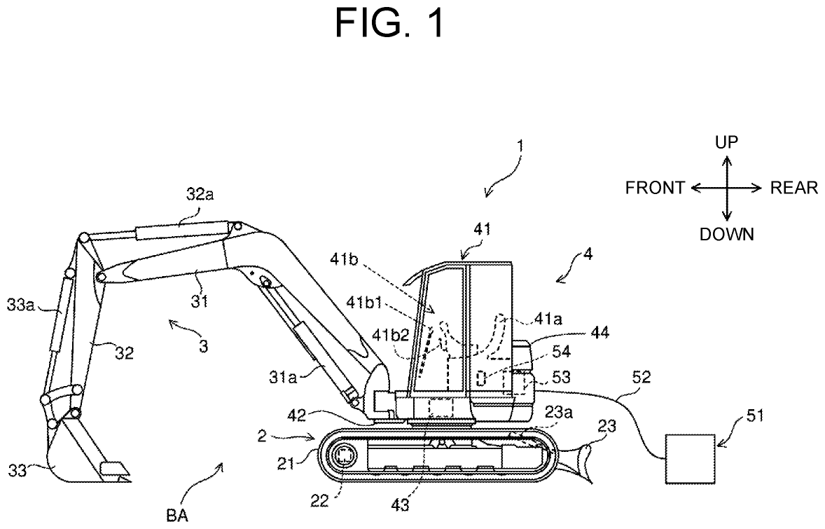

FIG. 1 is a side view showing a schematic configuration of a hydraulic shovel 1 as an example of an electric work machine according to the present embodiment. The hydraulic shovel 1 includes a lower run body 2, a work instrument 3, and an upper turn body 4.

Here, in FIG. 1, directions are defined as follows. First, the direction in which the lower run body 2 linearly runs is defined as a front-back direction, one side of which being defined as “front” and another side being defined as “back”. In FIG. 1, a run motor 22 side relative to a blade 23 is shown as “front”, as an example. A transverse direction perpendicular to the front-back direction is a right-left direction. In this case, the left side is “left” and the right side is “right” as viewed from an operator (manipulator, driver) seated on an operation seat 41a. Further, the gravity direction perpendicular to the front-back and left-right directions is defined as an up-down direction, with the upstream side of the gravity direction being defined as “up” and the downstream side being defined as “down”.

The lower run body 2 is provided with a pair of right and left crawlers 21 and a pair of right and run motors 22. Each of the run motors 22 is a hydraulic motor. Each of the right and left run motors 22 drives one of the corresponding right and left crawlers 21, thereby making it possible to move the hydraulic shovel 1 forward and backward. A blade 23 for performing a ground leveling work and a blade cylinder 23a are provided on the lower run body 2. The blade cylinder 23a is a hydraulic cylinder to turn the blade 23 in the up-down direction.

The work instrument 3 has a boom 31, an arm 32, and a bucket 33. The boom 31, the arm 32, and the bucket 33 are independently driven, thereby to make it possible to perform excavation work of earth and sand.

The boom 31 is turned by a boom cylinder 31a. The boom cylinder 31a has a base end part thereof supported by a front part of the upper turn body 4, and is freely movable in an extendable and retractable manner. The arm 32 is turned by an arm cylinder 32a. The arm cylinder 32a has a base end part thereof supported by a tip part of the boom 31, and is freely movable in an extendable and retractable manner. The bucket 33 is turned by a bucket cylinder 33a. The bucket cylinder 33a has a base end part thereof supported by a tip part of the arm 32, and is freely movable in an extendable and retractable manner. The boom cylinder 31a, the arm cylinder 32a, and the bucket cylinder 33a each include a hydraulic cylinder.

The upper turn body 4 is so configured as to be turn relative to the lower run body 2 via a turn bearing (not shown). In the upper turn body 4, an operation unit 41, a turn base 42, a turn motor 43, an engine chamber 44, etc. are placed. Driving of the turn motor 43 as a hydraulic motor causes the upper turn body 4 to turn via the turn bearing.

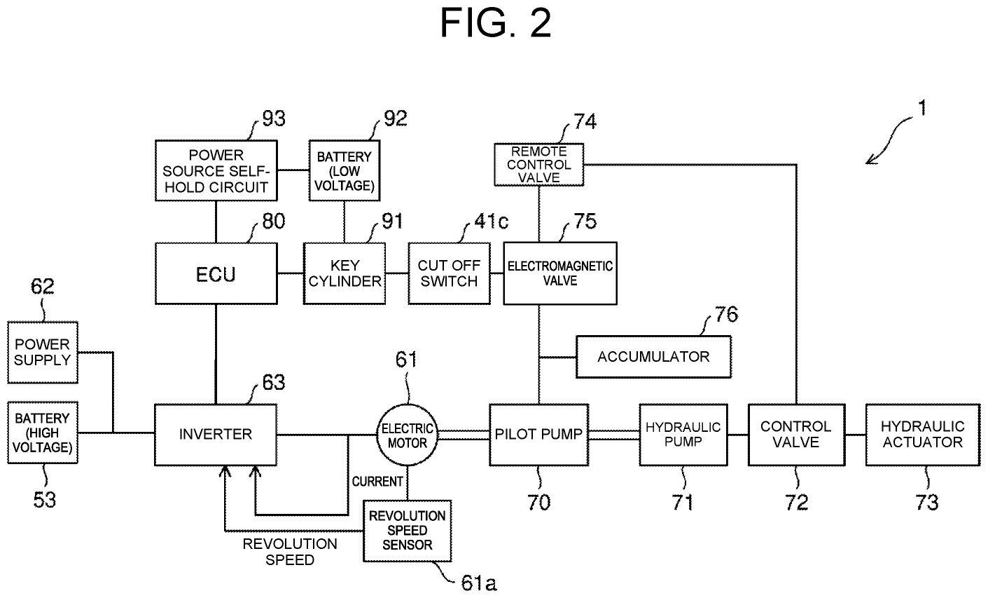

A plurality of hydraulic pumps 71 (see FIG. 2) is placed in the upper turn body 4. Each of the hydraulic pumps 71 is driven by an electric motor 61 (see FIG. 2) inside the engine chamber 44. Each of the hydraulic pumps 71 supplies a hydraulic oil (pressure oil) to the hydraulic motors (for example, the right and left run motors 22 and the turn motor 43) and the hydraulic cylinders (for example, the blade cylinder 23a, the boom cylinder 31a, the arm cylinder 32a, the bucket cylinder 33a). The hydraulic motor and hydraulic cylinder that are driven with the hydraulic oil supplied from any of the hydraulic pumps 71 are collectively referred to as a hydraulic actuator 73 (see FIG. 2).

The operation seat 41a is placed in the operation unit 41. Various levers 41b are placed around the operation seat 41a. The operator seated on the operation seat 41a and operating the lever 41b drives the hydraulic actuator 73. This allows the lower run body 2 to run, the blade 23 to perform the ground leveling work, the work instrument 3 to perform an excavation work, and the upper turn body 4 to turn.

In particular, the levers 41b include a cut-off lever 41b2 other than an operation lever 41b1 for driving the hydraulic actuator 73. The cut-off lever 41b2 is so provided on the left of the operation seat 41a as to turn up and down. The turn position of the cut-off lever 41b2 is detected by a cut-off switch 41c (see FIG. 2). The cut-off switch 41c is placed at a base end part of the cut-off lever 41b2.

The operator, by pressing down the cut-off lever 41b2, turns on the cut-off switch 41c; in conjunction with this, an electromagnetic valve 75 (see FIG. 2) described below is powered. As a result, the operator operates the given operation lever 41b1, making it possible to drive the given hydraulic actuator 73. Meanwhile, the operator, by pulling up the cut-off lever 41b2, turns off the cut-off switch 41c; in conjunction with this, the electromagnetic valve 75 is powered to be cut off. In this case, even the operator, by operating the operation lever 41b1, cannot drive the hydraulic actuator 73. When attempting to get off the operation unit 41, the operator pulls up the cut-off lever 41b2 thereby to disable the hydraulic actuator 73, and then leaves the operation seat 41a.

Thus, the hydraulic shovel 1 of the present embodiment has the cut-off lever 41b2 that is turned up and down by the operator, and the cut-off switch 41c that, in conjunction with the action of turning the cut-off lever 41b2 upward, de-powers and cuts off the electromagnetic valve 75.

A battery 53 (for example, lithium-ion battery) is mounted on the upper turn body 4. The power supplied from the battery 53 can drive the electric motor 61. Further, the upper turn body 4 is provided with a power supply port (not shown). The power supply port and a commercial power source 51 as an external power source are connected via a power supply cable 52. This also allows for charging of the battery 53.

Further, when the lower run body 2, the work instrument 3, and the upper turn body 4 are collectively defined as a machine body BA, the machine body BA may be driven by a combination of electric power and a hydraulic instrument. That is, the machine body BA may include an electric run motor, an electric cylinder, an electric turn motor, etc., other than the hydraulic instrument such as the hydraulic actuators 73.

### [2. Configurations of Control and Hydraulic Systems]

FIG. 2 is a block diagram schematically showing a configuration of control and hydraulic systems of the hydraulic shovel 1. The hydraulic shovel 1 is provided with an electric motor 61.

The electric motor 61 is driven by electric power supplied from at least one of the commercial power source 51 and the battery 53 via an inverter 63 to be described below. The electric motor 61 includes a permanent magnet motor or an induction motor. Further, for fitting the electric motor 61 to a small work machine such as a mini shovel, it is desirable, from the viewpoint of a compact size and an excellent layout property, to include a permanent magnet motor, rather than an induction motor, in the electric motor 61.

A pilot pump 70 and a plurality of hydraulic pumps 71 are connected to a rotary shaft (output shaft) of the electric motor 61. The pilot pump 70 discharges a pilot oil which serves as an input command to the control valve 72. The control valve 72 is a direction switching valve that controls the flow direction and flowrate of the pressure oil supplied from the hydraulic pump 71 to hydraulic actuators 73, and is provided for each of the hydraulic actuators 73.

The plurality of hydraulic pumps 71 includes a variable-capacity pump and a fixed-capacity pump. FIG. 2 shows only one hydraulic pump 71 as an example. The hydraulic pump 71 causes the hydraulic oil in a hydraulic-oil tank (not shown) to be supplied, as the pressure oil, via the control valve 72 to the hydraulic actuator 73. This drives the hydraulic actuator 73.

That is, the hydraulic shovel 1 in the present embodiment has the electric motor 61, the hydraulic actuator 73 driven by a supply of the pressure oil, the hydraulic pump 71 that is driven by the electric motor 61 and supplies pressure oil to the hydraulic actuator 73, the control valve 72 that controls the flow direction and flowrate of the pressure oil supplied from the hydraulic pump 71 to the hydraulic actuator 73, and the pilot pump 70 that is driven by the electric motor 61 and discharges the pilot oil as the input command to the control valve 72.

The hydraulic shovel 1 is further provided with a remote control valve 74, an electromagnetic valve 75, and an accumulator 76. The remote control valve 74 is provided so as to switch the direction and pressure of the pilot oil supplied from the pilot pump 70 to the control valve 72. The remote control valve 74 is included in an operation lever 41b1 and, in accordance with the operation direction and operation amount of the operation lever 41b1, reduces the pressure (pilot pressure) of a pilot oil, which is supplied from the pilot pump 70, thereby to generate a pilot secondary pressure. Thus, the hydraulic shovel 1 of the present embodiment is provided with the remote control valve 74 that, in response to the operator's operation, controls the pilot oil's being supplied from the pilot pump 70 to the control valve 72.

The electromagnetic valve 75 is positioned in an oil path between the pilot pump 70 and the remote control valve 74, and controls the supply of the pilot oil (pilot pressure) from the pilot pump 70 to the remote control valve 74. The accumulator 76 is positioned in an oil path that branches from the pilot oil's oil path extending from the pilot pump 70 to the electromagnetic valve 75. That is, the electromagnetic valve 75 is positioned in the oil path between the accumulator 76 and the remote control valve 74. Then, the accumulator 76 accumulates the pilot pressure generated by the pilot pump 70.

The actual rotation speed (real rotation speed) of the electric motor 61 is detected by a rotation speed sensor 61a. The rotation speed sensor 61a includes a resolver, an encoder, a Hall element, etc. The information on the rotation speed of the electric motor 61 which speed is detected by the rotation speed sensor 61a is input to the inverter 63, and is subjected to a below-described feedback control in the inverter 63.

The hydraulic shovel 1 is further provided with a power supply 62, the inverter 63, and an ECU (Electronic Control Unit) 80. Into the DC voltage, the power supply 62 converts the AC voltage supplied from the commercial power source 51 via the power supply cable 52.

Into the AC voltage, the inverter 63 converts the DC voltage output from the power supply 62 or supplied from the battery 53, thereby to supply the AC voltage to the electric motor 61. As a result, the electric motor 61 is rotated. The supply of the AC voltage (current) from the inverter 63 to the electric motor 61 is performed based on a rotation command output from the ECU 80.

The inverter 63 acquires a deviation between the electric motor 61's rotation speed (set rotation speed) set in the above rotation command and the electric motor 61's actual rotation speed detected by the rotation speed sensor 61a, and performs the feedback control to control the output (for example, current) from the inverter 63 to the electric motor 61 so that the deviation becomes small (so that the actual rotation speed approaches the set rotation speed). Further, the set rotation speed is set to a value greater than or equal to zero and less than or equal to a target rotation speed Rs to be finally reached at the time of starting the electric motor 61.

The above feedback control is, for example, PI control (proportional-integral control), but is not limited to this and may be P control (proportional control) or PID control (proportional-integral-derivative control).

THE ECU 80 includes an electronic control unit or CPU that functions as a control unit for controlling the inverter 63. That is, the hydraulic shovel 1 of the present embodiment is provided with the inverter 63 that supplies power to the electric motor 61 and the ECU 80 that controls the inverter 63. Further, the ECU 80 receives a powering signal of the electromagnetic valve 75. This allows the ECU 80 to recognize the powered state/de-powered state of the electromagnetic valve 75.

Further, the hydraulic shovel 1 is provided with a key cylinder 91. A key for the operator to give a command for drive-on, drive-start, and drive-off with respect to the drive of the electric motor 61 is inserted in the key cylinder 91. The key cylinder 91 incorporates a sensor that detects the key's turn positions (key on position, key start position, and key off position) which correspond to the drive-on, the drive-start, and the drive-off, respectively. That is, the key cylinder 91 is included in a command detection unit that detects the operator's commands for driving the electric motor 91. The detection signal corresponding to the turn position of the key is output from the key cylinder 91 to the ECU 80. Further, the command detection unit may be so configured as to detect the commands of the respective drive-on, drive-start, and drive-off based on the number of times the press button is pressed or based on the pressing time.

Also, the hydraulic shovel 1 is further provided with a battery 92 and a power source self-hold circuit 93. The battery 92 includes a lead-acid battery that outputs a low voltage (for example, 12 V). Supplying power from the battery 92 to the key cylinder 91 makes it possible to detect, in the key cylinder 91, the turn position of the key.

The power source self-hold circuit 93 is a circuit that holds the power source (electric power) of the battery 92 for a certain time period. In the key cylinder 91, even turning the key from the drive-on position (key-on position) to the drive-off position (key-off position) keeps the power source for a while by the power source self-hold circuit 93, supplying the power to the ECU 80 and an electric component (accessory). Then, after the rotation of the electric motor 61 completely stops, the power source self-hold circuit 93's supplying the power source to the ECU 80 and the electric component is cut off

### [3. Action of Hydraulic Shovel]

Next, an action of the hydraulic shovel 1 having the above configuration is to be described.

### (3-1. Basic Action)

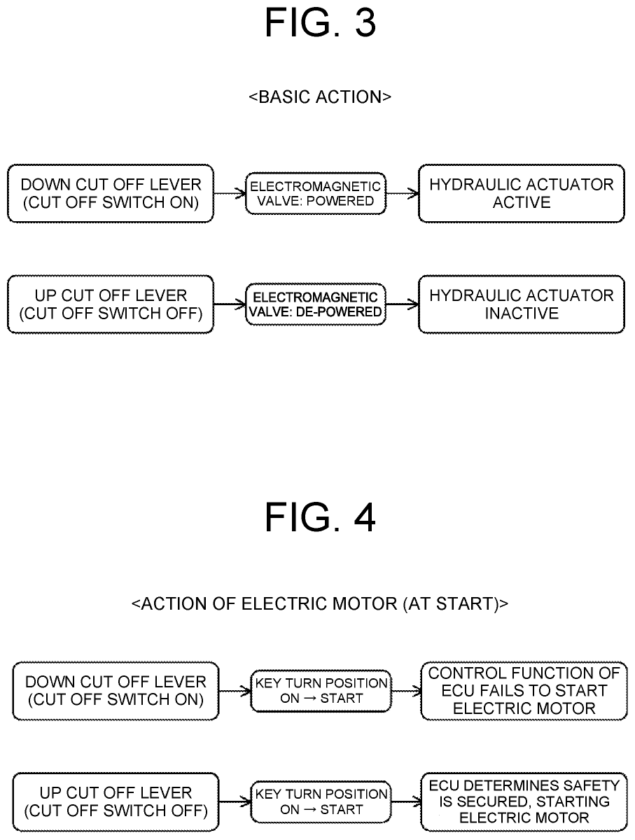

First, as a basic action of the hydraulic shovel 1, the driving of the hydraulic actuator 73 by the turn of the cut-off lever 41b2 is to be explained. FIG. 3 shows the relation between the turn position of the cut-off lever 41b2 and the action state of the hydraulic actuator 73. When the cut-off lever 41b2 is so turned downward as to block the exit of the operation unit 41, the cut-off switch 41c is on, as described above. In this case, the electromagnetic valve 75 becomes powered, making it possible to output the pilot pressure from the electromagnetic valve 75 to the downstream side (remote control valve 74 side). The remote control valve 74 is connected with an input port of the control valve 72; thus, outputting the pilot pressure from the remote control valve 74 in response to the movement of the operation lever 41b1 moves a spool of the control valve 72, supplying the pressure oil to the hydraulic actuator 73 that corresponds to the movement of the operation lever 41b1. As a result, the hydraulic actuator 73 is driven.

Meanwhile, when the cut-off lever 41b2 is turned upward, the cut-off switch 41c is in the off state as described above. In this case, the electromagnetic valve 75 is de-powered and cut off. As a result, the pilot pressure cannot be output from the remote control valve 74, causing the hydraulic actuator 73 to be un-drivable.

### (3-2. Startability of Electric Motor)

Next, the startability seen when the operator turns the key thereby to start the electric motor is to be explained. FIG. 4 shows the turn position of the cut-off lever 41b2 and the turn position of the key, relative to the startability of the electric motor. When the operator is seated on the operation seat 41a and immediately turns the cut-off lever 41b2 downward (cut-off switch 41c is on), the ECU 80 determines that safety is not secured. In this case, even the operator inserting the key into the key cylinder 91 thereby to turn the key fails to cause the ECU 80 to output the rotation command to the inverter 63, failing to start the electric motor 71 (start check function). Meanwhile, when the cut-off lever 41b2 is turned upward (cut-off switch 41c is off), the ECU 80 determines that safety is secured. In this case, the operator inserting the key into the key cylinder 91 thereby to turn the key from the key-off position via the key-on position to the key-start position causes the ECU 80 to output the rotation command to the inverter 63 based on the input of the key-start position detection signal.

The above rotation command is a command (control signal) for causing the rotation speed of the electric motor 61 to reach the target rotation speed Rs in an optional time. The above target rotation speed Rs is preset by the operator operating a dial provided on the side of the operation seat 41a, for example. The ECU 80 can recognize the set target rotation speed Rs based on the turn position of the dial.

The inverter 63 supplies power to the electric motor 61 based on the rotation command. This causes the electric motor 61 to start (begin) rotating, and the rotation speed of the electric motor 61 slowly increases. Rotating of the electric motor 61 revolves the pilot pump 70 and the hydraulic pump 71.

Here, when the cut-off lever 41b2 is turned upward, the cut-off switch 41c is turned off as described above, putting the electromagnetic valve 75 in the de-powered state, thus failing to drive the hydraulic actuator 73. Then, the operator turns the cut-off lever 41b2 downward, thus turning on the cut-off switch 41c. This allows the electromagnetic valve 75 to become powered; thus the pilot oil (pilot pressure) is supplied from the pilot pump 70 via the electromagnetic valve 75 and the remote control valve 74 to the control valve 72, making it possible to drive the hydraulic actuator 73.

Further, the electromagnetic valve 75 is de-powered from the state of the cut-off lever 41b2 being turned upward until being turned downward; thus, the pilot pressure generated by the revolution of the pilot pump 70 is accumulated in the accumulator 76.

(3-3. Action of Hydraulic Shovel from Rotation to Stop of Electric Motor)

After the electric motor 61 is started, the key inserted into the key cylinder 91 is returned from the key start position to the key on position. Then, after the work with the hydraulic shovel 1 is ended, the operator turns the key from the key-on position to the key-off position, causing the ECU 80 to perform a control to stop the rotation of the electric motor 61. In the present embodiment, the ECU 80, after the cutting off of the electromagnetic valve 75 due to the electromagnetic valve 75 in the de-powered state, controls the inverter 63 thereby to stop the rotation of the electric motor 61. The process from the rotation to stop of the electric motor 61 is to be described in more detail below.

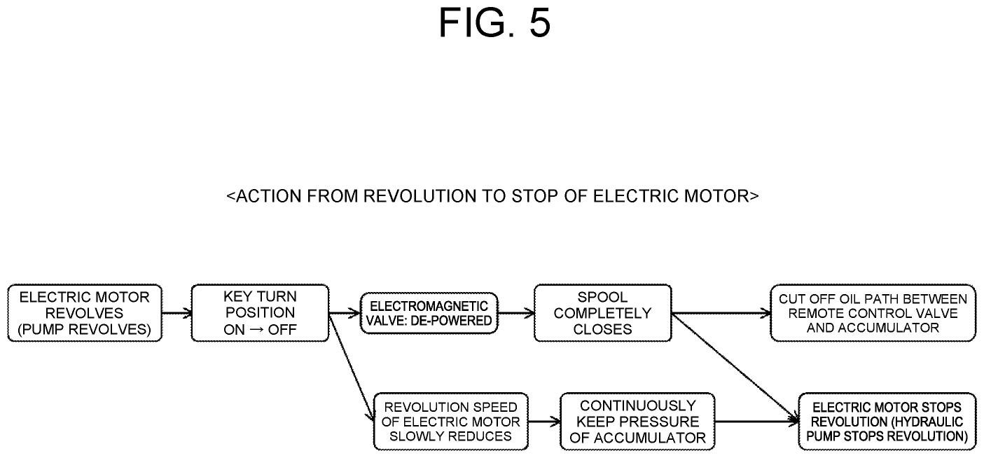

FIG. 5 shows in detail the process from the rotation to stop of the electric motor 61. After rotating the electric motor 61, the pilot pump 70, and the hydraulic pump 71 thereby to perform the work with the hydraulic shovel 1, the operator turns the key from the key-on position to the key-off position, thus de-powering the electromagnetic valve 75 due to the configuration of the electric circuit including the electromagnetic valve 75. The ECU 80 recognizes the de-powered state based on the powering signal from the electromagnetic valve 75, and outputs, to the inverter 63, a control signal that slowly reduces the speed (rotation speed) of the electric motor 61. Further, details of the control signal are to be described below. The inverter 73 gradually reduces, based on the control signal, the power supplied to the electric motor 61, thereby slowly reducing the rotation speed of the electric motor 61.

The electromagnetic valve 75 is de-powered, closing the spool of the electromagnetic valve 75, thus cutting off the oil path between the remote control valve 74 and the accumulator 76. This, even when a reduction in the rotation speed of the electric motor 61 reduces the pilot pressure accumulated in the accumulator 76, reduces the pilot pressure's escaping via the electromagnetic valve 75 to the remote control valve 74 side. Then, the electric motor 61 stops rotating, thus stopping the rotation of the pilot pump 70 and the hydraulic pump 71.

### (About Control Signal at Reduced Rotation Speed)

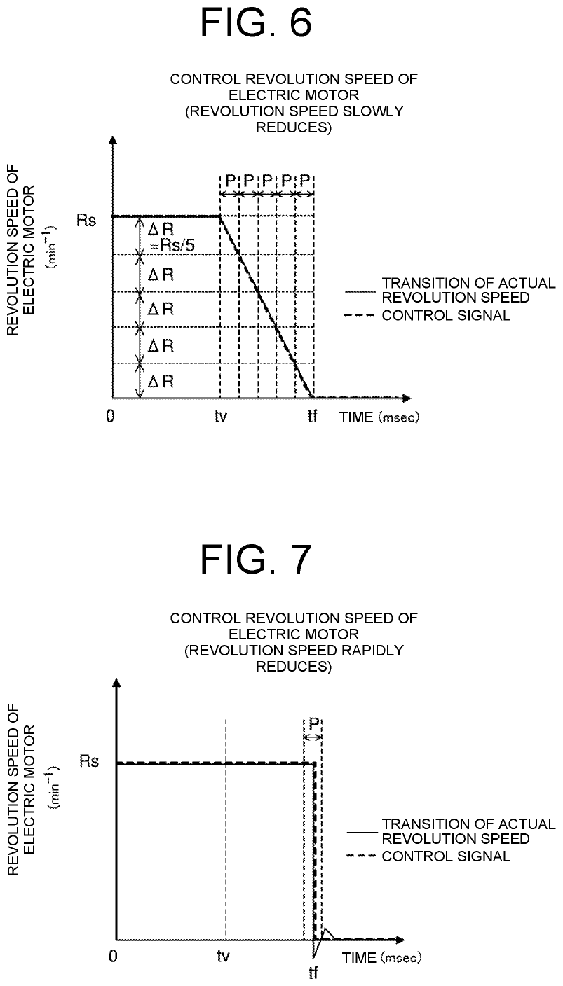

Next, a detailed description is to be made on the control signal. FIG. 6 shows the control signal (graph of dash line) generated by the ECU 80 at the time of stopping the rotation of the electric motor 61 (driving of the hydraulic shovel 1), and a transition (see graph of solid line) of the actual rotation speed of the electric motor 61 which transition is seen when the inverter 63 stops the rotation of the electric motor 61 based on the control signal. In the present embodiment, the ECU 80, when stopping the rotation of the electric motor 61, so controls the inverter 63 that the rotation speed of the electric motor 61 reduces (from the target rotation speed Rs (min⁻¹)) to zero via a plurality of control periods P (msec) in such a manner that the rotation speed is smaller period after period in the control periods P. Further, the above control period P refers to the time period as a unit in which the ECU 80 controls the rotation speed of the electric motor 61.

In the example in FIG. 6, the ECU 80 generates the control signal that reduces the rotation speed of the electric motor 61 by Rs/5 during one control period P and repeats this by five periods thereby to finally reduce the rotation speed of the electric motor 61 from the target rotation speed Rs to zero. The inverter 63, when driving the electric motor 61 based on the above control signal, causes the rotation speed of the electric motor 61 to substantially linearly reduce with an elapse of time to reach zero. Further, the rotation of the electric motor 61 stops after the electromagnetic valve 75 is de-powered to be cut off; thus, a time tf seen when the rotation speed of the electric motor 61 reaches zero is later than a time (for example, time tv) for completely closing the spool of the electromagnetic valve 75.

Further, the change in the actual rotation speed of the electric motor 61, which change is seen when stopping the rotation of the electric motor 61 based on the control signal, is expressed as a function with time as a variable. When the above function is expressed as a linear function, for example, integrating the reduction amount in rotation speed (which corresponds to the slope of a linear part) over a given interval (the time for rotation speed to reach zero from the target rotation speed Rs) can acquire the above linear function.

In the example in FIG. 6, a reduction amount ΔR of the rotation speed of the electric motor 61 is defined as Rs/5 for any of the five control periods P, but the reduction amount ΔR may be a value different with the respective control periods P. For example, the rotation speed reduction amount ΔR in the five control periods P may be 2Rs/20, 3Rs/20, 4Rs/20, 5Rs/20, and 6Rs/20, respectively.

Further, in the example in FIG. 6, the ECU 80 generates the control signal that continuously reduces the rotation speed (monotonically reduces the rotation speed) over a plurality of control periods P, but may also generate a control signal that reduces the rotation speed in step. For example, the ECU 80 may generate the control signal that keeps the rotation speed constant at 4Rs/5 in the first control period P, keeps the rotation speed constant at 3Rs/5 in the next control period P, keeps the rotation speed constant at 2Rs/5 in the next control period P, keeps the rotation speed constant at Rs/5 in the next control period P, and causes the rotation speed to reach zero in the next control period P. Further, the ECU 80 may generate a control signal that rapidly reduces the rotation speed of the electric motor 61. FIG. 7 shows another control signal generated by the ECU 80 at the time of stopping the rotation of the electric motor 61, and a transition (see the graph of solid line) of the actual rotation speed of the electric motor 61 which transition is seen when the inverter 63 stops the rotation of the electric motor 61 based on the other control signal. Even when rapidly reducing the rotation speed of the electric motor 61 during the one control period P, adjusting the timing of zeroing the rotation speed of the electric motor 61 can stop the rotation of the electric motor 61 at the time tf later than the time tv for completely closing the spool of the electromagnetic valve 75. Thus, even when the above control signal is used; after cutting off the electromagnetic valve 75, the pilot pressure's escaping, which pressure is accumulated in the accumulator 76, via the electromagnetic valve 75 to the remote control valve 74 side is reduced.

However, the electric motor 61's rotation speed control based on the control signal shown in FIG. 7, due to the rapid reduction in the rotation speed of the electric motor 61 in a short time period, results in a pronounced undershoot. Herein, the undershoot refers to a phenomenon in which the rotation speed of the electric motor 61 falls below zero (reverse rotation). The concern is that occurrence of the undershoot inversely revolves the hydraulic pump 71, causing a failure to the hydraulic pump 71. Thus, from the viewpoint of reducing the hydraulic pump 71's failures due to the undershoot, it is desirable to perform the rotation speed control that is based on the control signal shown in FIG. 6 rather than in FIG. 7.

(3-4. About Driving Hydraulic Actuator after Stop of Electric Motor)

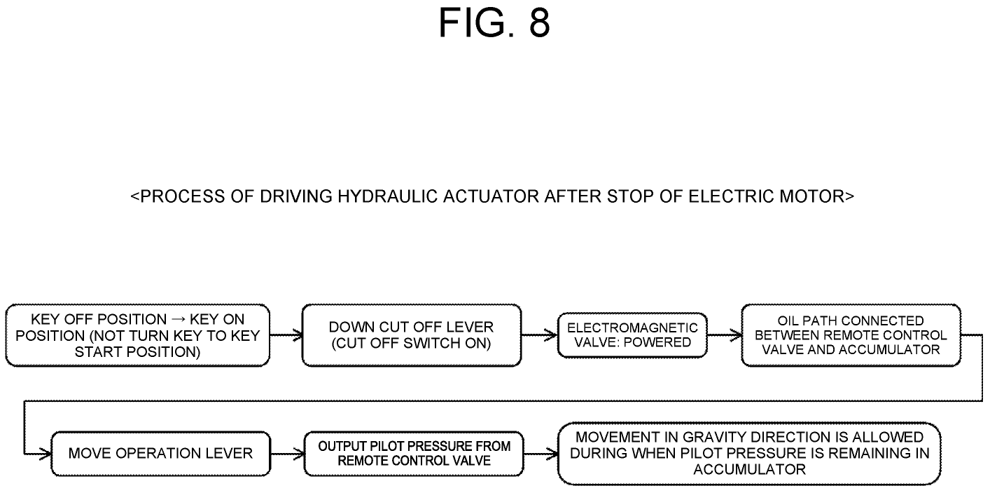

FIG. 8 shows the process seen when the hydraulic actuator 73 is actuated based on a key operation by the operator after stopping the rotation of the electric motor 61. The operator getting in the operation unit 41 then to turn the key from the key-off position to the key-on position (not turn the key to the key-start position) and to turn the cut-off lever 41b2 downward turns on the cut-off switch 41c, powering the electromagnetic valve 75. This connects, via the electromagnetic valve 75, the oil path between the remote control valve 74 and the accumulator 76, allowing the remote control valve 74 to output the pilot pressure accumulated in the accumulator 76. Thus, moving the operation lever 41b1 thereby to output the pilot pressure from the remote control valve 74 to the control valve 72, and moving the spool of the control valve 72 makes it possible to drive the hydraulic actuator 73 for a certain time period (until the pilot pressure accumulated in the accumulator 76 becomes zero) in a given direction (for example, gravity direction).

### [4. Effect]

As described above; in the present embodiment, the rotation of the electric motor 61 stops after the cutting off of the electromagnetic valve 75 due to the electromagnetic valve 75 in the de-powered state (see FIG. 5). This, even when the reduction in the rotation speeds of the electric motor 61 and pilot pump 70 reduces the pilot pressure accumulated in the accumulator 76, reduces the pilot pressure's escaping via the electromagnetic valve 75 to the remote control valve 74 side. That is, the pressure drop of the pilot pressure accumulated in the accumulator 76 can be delayed. As a result, even after the stop of driving the electric motor 61, the pilot pressure's accumulation in the accumulator 76 can be kept.

Thus, the time capable of supplying the pilot pressure, which is accumulated in the accumulator 76, via the remote control valve 74 to the pilot valve 72, when the electromagnetic valve 75 is powered and opened while stopping the rotation of the electric motor 61 (pilot pump 70 is stopped) can be longer than, for example, when the electric motor 61 is stopped before cutting off the electromagnetic valve 75. As a result, even when the driving of the electric motor 61 is stopped, the hydraulic oil is supplied from the hydraulic pump 71 to the hydraulic actuator 73, making it possible to secure a long time for driving the hydraulic actuator 73. Thus, even when the hydraulic actuator 73 is stopped in a dangerous position (for example, upper position) after the stop of driving the electric motor 61, the hydraulic actuator 73, without driving the electric motor 61, is actuated for a certain time thereby to make it possible to move to a safe position (lower position) with a margin, making it possible to reliably secure the surrounding safety.

In particular, the electromagnetic valve 75 is positioned in the oil path between the accumulator 76 and the remote control valve 74. This can reliably realize a configuration in which the cutting off of the electromagnetic valve 75 reduces the pilot pressure's escaping from the accumulator 76 to the remote control valve 74, and in which opening of the electromagnetic valve 75 supplies the pilot pressure from the accumulator 76 via the remote control valve 74 to the control valve 72.

Further, the ECU 80, when stopping the rotation of the electric motor 61, so controls the inverter 63 that the rotation speed of the electric motor 61 reduces to zero via a plurality of control periods P in such a manner that the rotation speed is smaller period after period in the control periods P, thus making it possible to gradually (slowly) reduce the rotation speed of the electric motor 61 over a plurality of control periods P. The electromagnetic valve 75 has a response time; thus, slowly stopping the electric motor 61 can delay the stop timing of the electric motor 61 after the end (cut-off timing) of the response time of the electromagnetic valve 75. This reduces the situation where the pressure accumulated in the accumulator 76 before the stop of driving the electric motor 61 is removed via the electromagnetic valve 75, making it possible to keep the pressure accumulated in the accumulator 76.

### [5. Idle Stop Control]

The ECU 80 in the present embodiment may have a function to perform an idle stop control. The idle stop control is a control that, when the cut-off lever 41b2 is turned upward, stops the rotation of the electric motor 61.

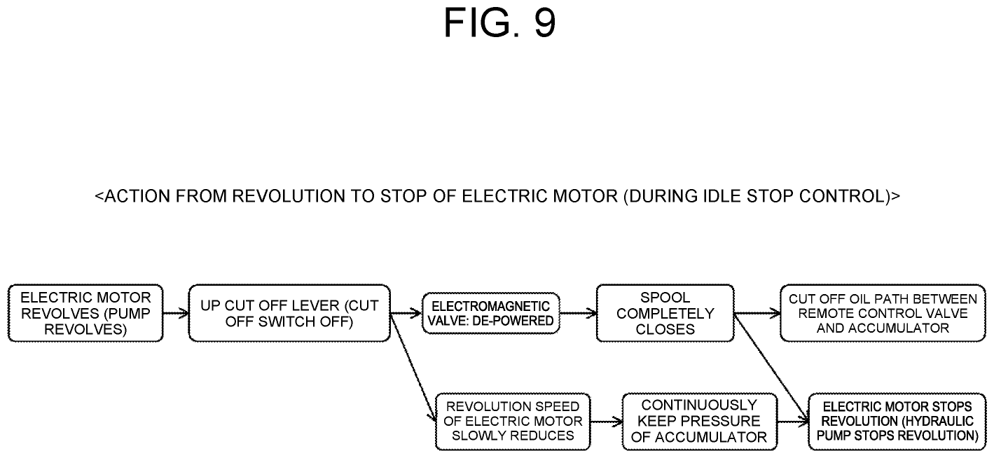

FIG. 9 shows the process of stopping, by the idle stop control, the rotation of the electric motor 61. After rotating the electric motor 61, the pilot pump 70, and the hydraulic pump 71 thereby to perform the work with the hydraulic shovel 1, the operator turning the cut-off lever 41b2 upward causes the ECU 80 to enter the control to stop the rotation of the electric motor 61 (idle stop control). At this time, the ECU 80 generates the control signal shown in FIG. 6, and outputs the control signal to the inverter 63. This causes the rotation speed of the electric motor 61 to gradually reduce from the target rotation speed Rs, and finally becomes zero. Meanwhile, the operator turning the cut-off lever 41b2 upward turns off the cut-off switch 41c, and in conjunction with this, the electromagnetic valve 75 is de-powered thereby to close the spool of the electromagnetic valve 75. This cuts off the oil path between the remote control valve 74 and the accumulator 76.

In this way, the cut-off switch 41c de-powering and cutting off the electromagnetic valve 75 in conjunction with the action of turning the cut-off lever 41b2 upward makes it possible to reliably perform the control that first cuts off the electromagnetic valve 75 and then stops the rotation of the electric motor 61.

The above describes the configuration in which the electromagnetic valve 75 switches between the powered and de-powered states in conjunction with the action of the cut-off switch 41c; however, it may be so made that the ECU 80 directly controls the electromagnetic valve 75 thereby to switch the electromagnetic valve 75 between the powered and de-powered states. Even in this case; after de-powering and cutting off the electromagnetic valve 75, the ECU 80, by controlling the inverter 63 thereby to stop the rotation of the electric motor 61, can keep the pilot pressure's accumulation in the accumulator 76.

Although description has been made using the hydraulic shovel 1, which is a construction machine, the an example of the electric work machine, the work machine is not limited to the hydraulic shovel 1, but may be another construction machine, such as a wheel loader or the like, and may be an agricultural machine, such as a combine harvester, a tractor, or the like.

The embodiment of the present invention has been described above, but the scope of the present invention is not limited thereto, and can be carried out within an extended or modified range without departing from the gist of the present invention.

### INDUSTRIAL APPLICABILITY

The present invention is applicable to a work machine such as a construction machine and an agricultural machine, for example.

### DESCRIPTION OF REFERENCE NUMERALS

1 hydraulic shovel (electric work machine)
41b2 cut-off lever
41c cut-off switch
61 electric motor
63 inverter
70 pilot pump
71 hydraulic pump
72 control valve (direction switching valve)
73 hydraulic actuator
74 remote control valve
75 electromagnetic valve
76 accumulator
80 ECU (control unit)
91 key cylinder

1. An electric work machine comprising:
an electric motor;
an inverter that supplies power to the electric motor;
a hydraulic actuator that is driven by a supply of a hydraulic oil;
a hydraulic pump that is driven by the electric motor, and supplies the hydraulic oil to the hydraulic actuator;
a direction switching valve that controls a flow direction and flowrate of the hydraulic oil supplied from the hydraulic pump to the hydraulic actuator; and
a pilot pump that is driven by the electric motor, and discharges a pilot oil serving as an input command to the direction switching valve;
a remote control valve that, in response to an operation of an operator, controls a supply of the pilot oil from the pilot pump to the direction switching valve;
an electromagnetic valve that controls the supply of the pilot oil from the pilot pump to the remote control valve;
an accumulator that is positioned in an oil path that branches from the pilot oil's oil path extending from the pilot pump to the electromagnetic valve, and that accumulates a pilot pressure generated by the pilot pump; and
a control unit that controls the inverter,
wherein
the control unit, after cutting off of the electromagnetic valve due to the electromagnetic valve in a de-powered state, controls the inverter thereby to stop a rotation of the electric motor.

2. The electric work machine according to claim 1, wherein the electromagnetic valve is positioned in the oil path between the accumulator and the remote control valve.

3. The electric work machine according to claim 1, wherein
the control unit so controls the inverter that, when stopping the rotation of the electric motor, a rotation speed of the electric motor reduces to zero via a plurality of control periods in such a manner that the rotation speed is smaller period after period in the control periods.

4. The electric work machine according to claim 1, having:
a cut-off lever that is turned up and down by the operator, and
a cut-off switch that de-powers and cuts off the electromagnetic valve in conjunction with an action of turning the cut-off lever upward.
